(19) United States
(12) Patent Application Publication
(10) Pub. No.: US 2018/0184686 A1
(43) Pub. Date: Jul. 5, 2018

(54) POST-PELLETING LIQUID APPLICATOR SYSTEMS

(71) Applicant: KEMIN INDUSTRIES, INC., Des Moines, IA (US)

(72) Inventors: Sathishkumar Jayaraman, Chennai (IN); Satish Kuttapa Kurup, Chennai (IN); Karthigan Manohar, Chennai (IN); Shaik Allavali, Chennai (TN); Krishnakumar Duraisamy, Coimbatore (IN)

(21) Appl. No.: 15/857,979

(22) Filed: Dec. 29, 2017

(30) Foreign Application Priority Data
Jan. 3, 2017 (IN) 201711000241

(51) Int. Cl. A23K 10/14; A23K 20/189; A23K 40/30; A23K 50/75

(52) U.S. Cl. CPC A23K 10/14; A23K 50/75; A23K 40/30; A23K 20/189

(57) ABSTRACT

The present invention is an apparatus for spraying a liquid onto pelleted feed, having a hopper with a gate for selectively holding or allowing the dropping of dry pellet feed, a spraying chamber below the hopper with an upper portion to receive the dropping dry pellet feed from the hopper, and a cylindrical lower portion, a cone operably attached to a motor, the cone rotatably disposed within the upper portion of the spraying chamber to direct dry pellet feed received into the upper portion into a single layer of falling feed around a circumference of the lower portion, an enzyme chamber, and a nozzle rotatably disposed within the lower portion to substantially evenly spray an amount of liquid from an enzyme chamber on the single layer of falling feed.

### CROSS-REFERENCE TO RELATED APPLICATIONS

This application claims priority to Indian Provisional Patent Application 2017/11000241, filed Jan. 3, 2017, entitled “POST-PELLETING LIQUID APPLICATOR SYSTEMS,” the disclosure of which is hereby incorporated by reference in its entirety.

### BACKGROUND OF THE INVENTION

The present invention relates generally to liquid application systems and, more specifically, to the efficient and uniform application of a small volume of liquid to pellets of animal feed.

The supplementation of exogenous enzymes has become an essential tool in animal feed industry to improve the nutritional value of the feed. A large number of poultry operations are using pelleted feed to improve animal performance. The conventional pelleting process involves mixing, conditioning, pressing and cooling of feed. The feed additives are added in a dry form in the mixing step. A pellet feed mill operates typically at a temperature range of 70-80° C. and 45 psi pressure. The high temperature is obligatory in the process to improve the feed quality and decrease the microbial load. The high temperatures and pressures of the conventional process will cause loss of heat sensitive additives in the feed. This poses a major challenge for use of thermo labile feed supplements, such as enzymes. The development of heat stable enzymes is one of the ways to address this issue, but the choice of such enzymes is very limited. In the current market, few thermostable enzymes are available for use as pre-pelleting feed additives. In the case of multi-component enzymes, not all the enzymes present are thermostable. Moreover, the cost of producing a thermostable enzyme is relatively higher than non-thermostable enzymes. Thus, there has been a need for a process for the post-pelleting application of heat liable additives (enzyme) to deliver the appropriate dosage of enzymes to enhance the action of such enzymes, resulting in improved feed digestibility in the animal.

Conventional post-process application systems require accurate measurement of both the dry product and liquid application rates. This is typically performed using scales for batch systems or mass flow meters for continuous application of the liquid. For instance, the batch applications use specific ratios or amounts of dry and liquid material, where both are weighed and mixed in batches. Continuous systems, on the other hand, tend to incorporate computers and software, where the liquid application rate is controlled by the dry material flow rate.

In order to have a uniform distribution of the dry material to which the liquid is being applied, there are several factors and considerations that must be taken into account. For instance, the liquid droplet size should be considered, in order to ensure proper dispersion throughout the dry material. In addition, the temperature difference (ΔT) between the dry material and applied liquids may affect the mixing quality if the liquid solidifies or evaporates before it is thoroughly distributed in the mix. In some cases, the liquid may need to be atomized into smaller droplets as it is applied. This can be achieved, for instance, through the use of compressed air in the liquid supply stream, as well as through the use of custom liquid nozzles designed for the specific application. Once the dry and liquid products are combined, the system should allow enough retention time and mixing to provide a thoroughly mixed final product.

Another challenge in adding liquids after processing is the relationship between the volume of product and the volume of liquid to be added to the product. An example of this is the volume of the product and the volume of liquid being applied. For instance, assume a ton (2,000 pounds) of finished pelleted or kibble product with a density of 40 pounds per cubic foot. Dividing the amount of product to which the liquid is to be added by its density (2,000 pounds/40 pounds per cubic foot), results in the product occupying 50 cubic feet of volume. A cubic foot of volume holds 7.48 gallons of liquid. Multiplying 50 cubic feet times 7.48 gallons per cubic foot gives a volume of 374 gallons of initial product to which the liquid is to be applied.

By way of further example, assume that the feed manufacturer wants to add an enzyme, such as xylanase when wheat is used in the dry product, at a rate of 200 milliliters/ton. 200 ml of xylanase results in having only 0.528 gallons of liquid to add to the 374 gallons of dry product. This presents another problem, where the amount of liquid is inadequate to achieve proper dispersion throughout the mixture. Thus, it is necessary to add an additional amount of a carrier liquid, such as water, to have enough liquid to properly spread throughout the dry product and blend into the mixture.

There are few post-pelleting liquid application (PPLA) systems available in the global markets that address these needs. However, the cost of these PPLA systems is quite expensive (and in some instances, cost prohibitive). This limits the potential application in feed mills. Accordingly, the present invention describes the design and development of novel, cost effective PPLA systems to address the need in the feed mill industry.

### SUMMARY OF THE INVENTION

One aspect of the present invention includes an apparatus for spraying a liquid onto pelleted feed, having a hopper with a gate for selectively holding or allowing the dropping of dry pellet feed, a spraying chamber below the hopper with an upper portion to receive the dropping dry pellet feed from the hopper, and a cylindrical lower portion, a cone operably attached to a motor, the cone rotatably disposed within the upper portion of the spraying chamber to direct dry pellet feed received into the upper portion into a single layer of falling feed around a circumference of the lower portion, an enzyme chamber, and a nozzle rotatably disposed within the lower portion to substantially evenly spray an amount of liquid from an enzyme chamber on the single layer of falling feed.

Another aspect of the present invention includes an apparatus for spraying an enzyme solution onto dry feed, having a surge bin for receiving and storing dry feed, a hopper in communication with the surge bin to accept dry feed from the surge bin, the hopper having a gate for selectively holding or allowing the dropping of dry pellet feed, a spraying chamber below the hopper, the spraying chamber having an upper portion to receive the dropping dry pellet feed from the hopper, and a spraying portion below the upper portion, a cone rotatably attached within the upper portion of the spraying chamber to direct dry feed received into the upper portion into a single layer of falling feed radially around a circumference of the lower portion, an enzyme mixing chamber with an enzyme solution in fluid communication with the spraying portion, a nozzle in fluid communication with the enzyme mixing chamber and rotatably connected within the lower portion to substantially evenly spray an amount of liquid from an enzyme chamber onto individual pieces of the single layer of falling feed.

Yet another aspect of the present invention includes a method of evenly applying a liquid enzyme sulution to dry pellet feed including the steps of adding an amount of dry pellet feed into a surge bin, selectively dispensing the amount of dry pellet feed out of the surge bin onto a belt feeder, sensing the amount of dry pellet feed on the conveyer using a first load cell, conveying the amount of dry pellet feed on the belt feed into a hopper, sensing the amount of dry pellet feed in the hopper using a second load cell, selectively dispensing the amount of dry pellet feed from the hopper into a spray chamber having a cone-shaped upper portion with an open end and a cylindrical spray portion, arranging the amount of dry pellet feed into a single layer of feed dispersed around the circumference of the spray portion by providing a rotating cone within the upper portion, forming an enzyme mixture by mixing an amount of enzyme solution from a first batch tank and a diluent from a second batch tank in a static mixer, wherein the enzyme solution and the diluent are pumped to the static mixer by dosing pumps, sensing the amount of enzyme solution in the first batch tank using a third load cell, sensing the amount of diluent in the second batch tank using a fourth load cell, spraying individual pieces of the dry pellet feed by urging the enzyme mixture through a spinning nozzle, wherein the spinning nozzle is disposed in the spray portion below the rotating cone, and is in fluid communication with the static mixer.

These and other aspects, objects, and features of the present invention will be understood and appreciated by those skilled in the art upon studying the following specification, claims, and appended drawings.

### BRIEF DESCRIPTION OF THE DRAWINGS

FIG. 1 is a schematic representation of an embodiment of the vertical spinning cone system of the present disclosure.

FIG. 2 is a schematic representation of an embodiment of the automated feed flow control system of the present disclosure.

FIG. 3 is a schematic representation of an embodiment of the automated liquid flow control system of the present disclosure.

FIG. 4 is a flowchart representing an embodiment of the operational sequence of a PPLA system of the present disclosure.

FIG. 5 is a front elevation view of an embodiment of the present disclosure.

FIG. 6 is a graph of the droplet size analysis using a particle size analyzer.

FIG. 7 is the design a cross-sectional top view of the spray chamber including the nozzle system according to at least one embodiment.

FIG. 8 is a cross-sectional front view of the spraying pattern of the embodiment depicted in FIG. 7.

### DETAILED DESCRIPTION OF THE INVENTION

### Example 1—Design of a Vertical Spinning Cone (VSC) System

### Materials and Methods

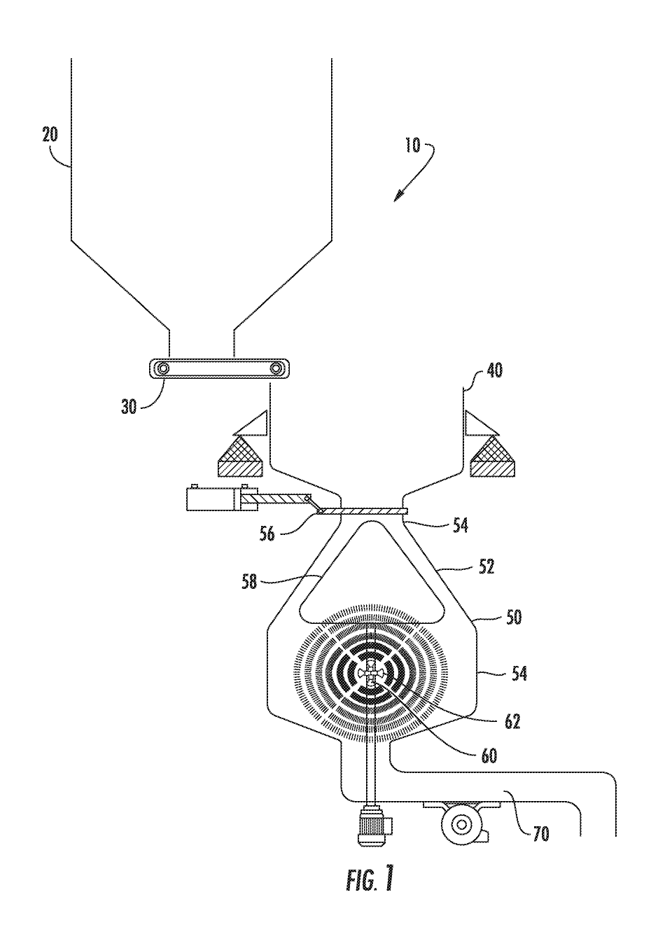

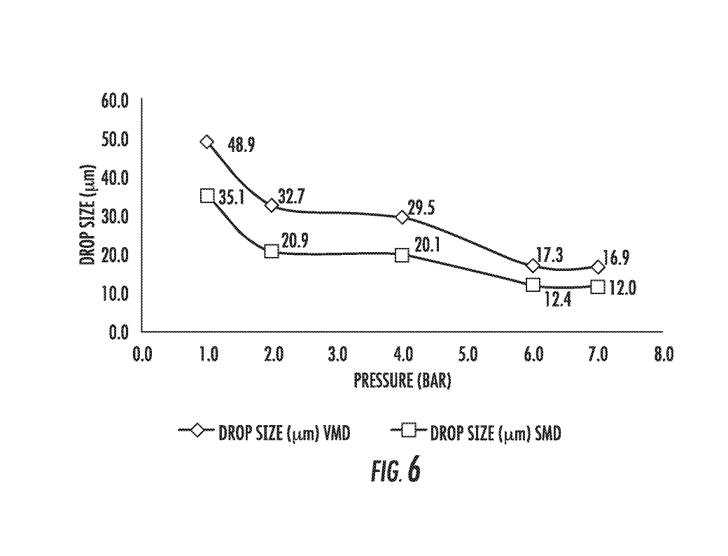

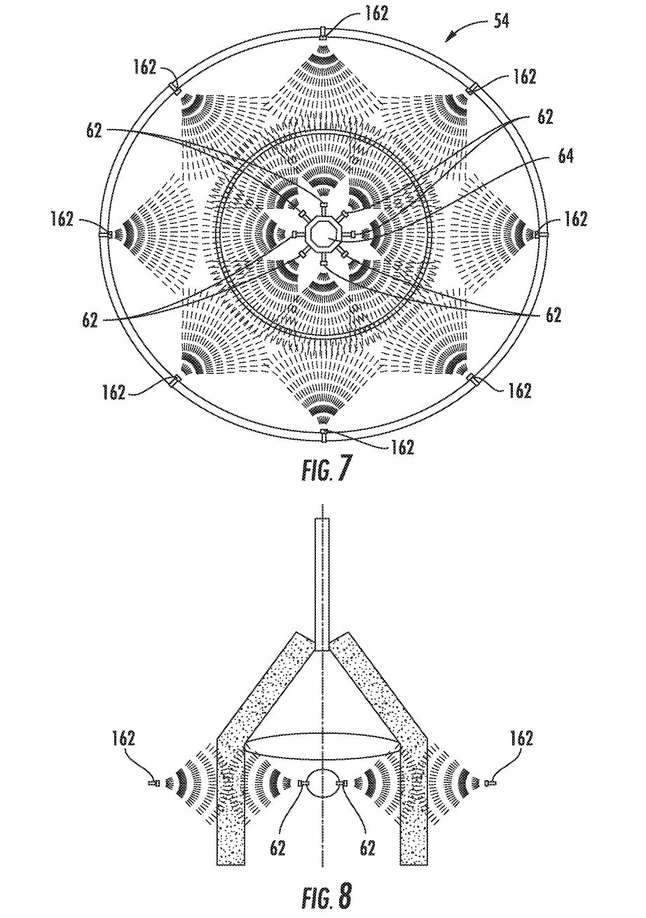

Design of VSC. The design of the VSC system 10 shown in FIG. 1 has a vertical feed flow pattern. The system may have a surge bin 20 on the top coupled with a first end 30a of a weighing belt conveyer 30. There may be a hopper 40 right below a second end 30b of the conveyer 30 to receive the free falling feed from the weighing conveyer 30. The hopper 40 may be directly connected with a top opening 54 of a spraying duct or chamber 50. The hopper may have a door or gate 56 that is selectively opened, either allowing the feed in the hopper 40 to drop into the spraying chamber 50, or hold it within the hopper 40. The spraying chamber 50 has a spinning cone 58 within the top portion 52 of the spraying chamber 50, the spinning cone 58 coupled to a motor 59. The rotating of the spinning cone enables the feed from the hopper 40 to fall into the lower or spray portion 54 of the spraying chamber 50 radially around the circumference of the cylindrical lower portion 54 as a substantially single sheet of individual pellets around the circumference of the chamber 50 for enzyme mixture spraying. The bottom portion 54 of the chamber may have a nozzle assembly 60 with rotary spraying nozzles 62. In another embodiment, a second group of nozzles 162 is disposed around the outside of spray chamber 54, and sprays the dry pellet feed from the outside in (see FIGS. 6 and 7), in addition to the nozzles 62 spraying from the inside out. An outlet port 70 may be located at the bottom of the chamber, in order to have a rapid discharge of the feed.

Components of post-pelleting liquid application (PPLA). According to least one embodiment of a PPLA system of the present invention, the following components may be used:

(a) Surge bin. The surge bin 20 is an initial storage unit for the pelleted feed. It may be provided with a level sensor to monitor the levels of feed present in the surge bin 20. The capacity of the surge bin is, for instance, 40 to 250 kg.

(b) Weighing conveyer. One of the ingredients that is metered is the feed. The weighing conveyer 30 assists in the metering of the pelleted feed flow from the surge bin 20.

(c) Spray area. The spray area 50 is a contained space where the feed is spray coated with an enzyme mixture or solution.

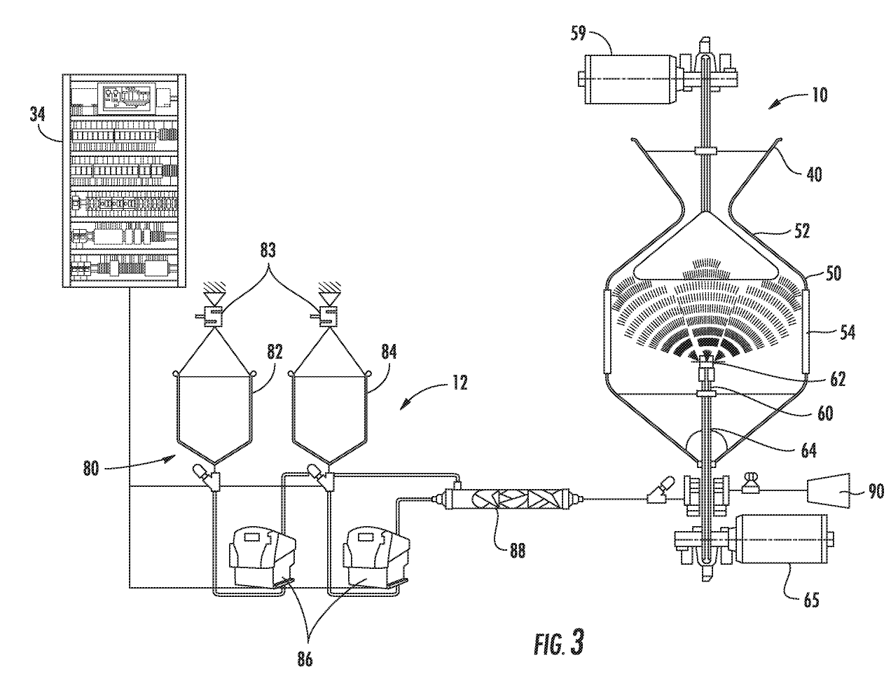

(d) VSC. The spray area of the VSC system is the spraying chamber 50. The spraying chamber is preferably 400 mm in diameter, and contains a pellet dispensing cone 58, preferably rotating at a speed 30 rpm, and a spinning spindle 64 coupled to a motor 65 as shown in FIG. 3 for nozzle assembly 60, which according to at least one embodiment operates or spins at a speed of 50 rpm. The cone 58 and the nozzle assembly 60 may both rotate about a common vertical axis. In at least one embodiment, the nozzle assembly 60 includes, for instance, four nozzles 62 arranged circumferentially at 90° to each other. According to at least one embodiment, each nozzle 62 is angled upwardly at 30° from horizontal, although the nozzles may be directed at any angle that allows the individual pellets to be coated.

(e) Enzyme batching unit 82 and diluent batching unit 84. The diluent and enzyme batching units 84, 82 preferably have 1 L to 5 L storage capacity and are used for diluent and enzyme storage, respectively. The batching units may be coupled with load cells 83 for accurate ingredient metering. The diluent may be any diluent known in the art, but according to at least one embodiment is water.

(f) Dosing pumps. A pump 86 may be connected to the enzyme batching unit 82, and another pump 86 may be connected to the diluent or water batching unit 84 for pumping the respective liquids from the batching units 82, 84. In at least one embodiment, the dosing pump 86 used is a ProMinent GALA Diaphragm Pump with a capacity of 4.4 LPH, 10 Bar pressure with analog control, but may be any pump that has the preferred capacity.

(g) Static mixer. The static mixer 88 is used to mix the enzyme and diluent or water proficiently. In at least one embodiment, the static mixer has a length of 150 mm with a diameter of 25 mm and a holding capacity of 100 mL, although the mixer may be any length sufficient to mix the enzyme solution and diluent properly.

Post-pelleting liquid application (PPLA) Operations. The PPLA systems may be completely automated and designed for one touch optimization of the process. The process optimization can be made using a touch screen display 35 on an automation panel 34. According to one embodiment, the entire operation is a one touch optimization process. The electric signals from pumps, static mixer, weighing conveyor, load cells, spraying nozzles, liquid batching units may be monitored and controlled respectively and automated by the automation panel 34. For example, the feed and liquid flow rate (amount of feed or liquid goes in per second) can be monitored and changed. Also, the enzyme batching can also be changed as and when required.

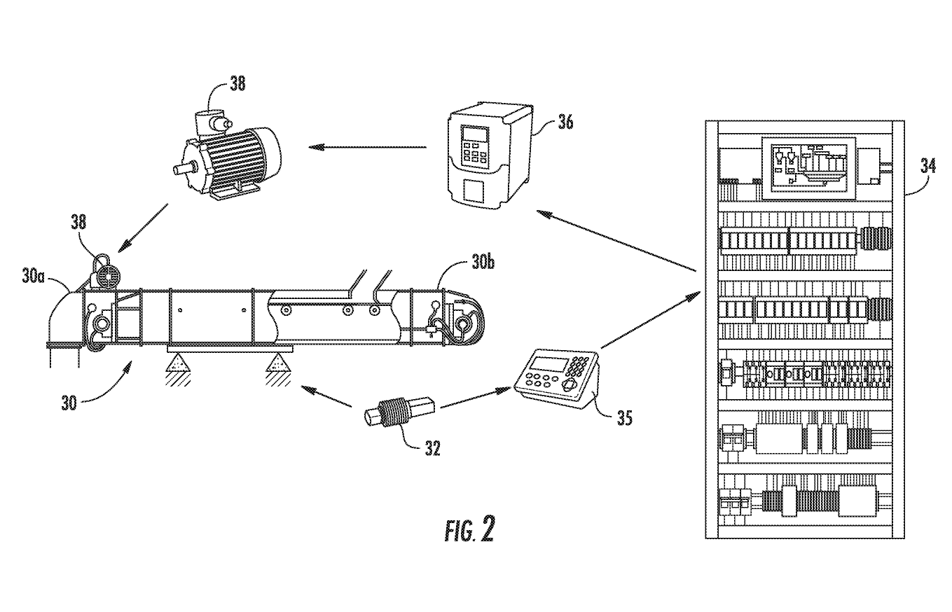

The feed flow control 10 and liquid flow control 12 systems are as described in FIGS. 2 and 3. In the feed flow control 10 shown schematically in FIG. 2, the weighing conveyer 30 may be coupled with a load cell 32 and is electrically connected to the automation panel 34, which displays to a user an amount of feed going in per second, for example. The conveyer 30 is operably connected to a motor 38 with variable frequency drive, which itself is connected to the panel 34 for controlled feed flow. The load cell 32 and the variable frequency drives 38 are electrically connected to the automation panel 34 and work synchronously. In the liquid flow system 12, the two liquid batching units 82, 84 may be coupled with load cells 83 and fluidly connected to the dosing pumps 86. The liquid is pumped to the static mixer 88 within which the two liquids are mixed in a measured fashion and then pumped to the nozzle assembly 60, either using the two batching unit pumps 86, or including a third pump solely to urge the mixed liquid from the static mixer to the nozzle assembly 60. The liquid pumped to the nozzle assembly 60 is sprayed through the nozzle 62 onto the single sheet of dry pellet feed that is falling about the circumference of the spray chamber with the help of compressed air from a compressor 90.

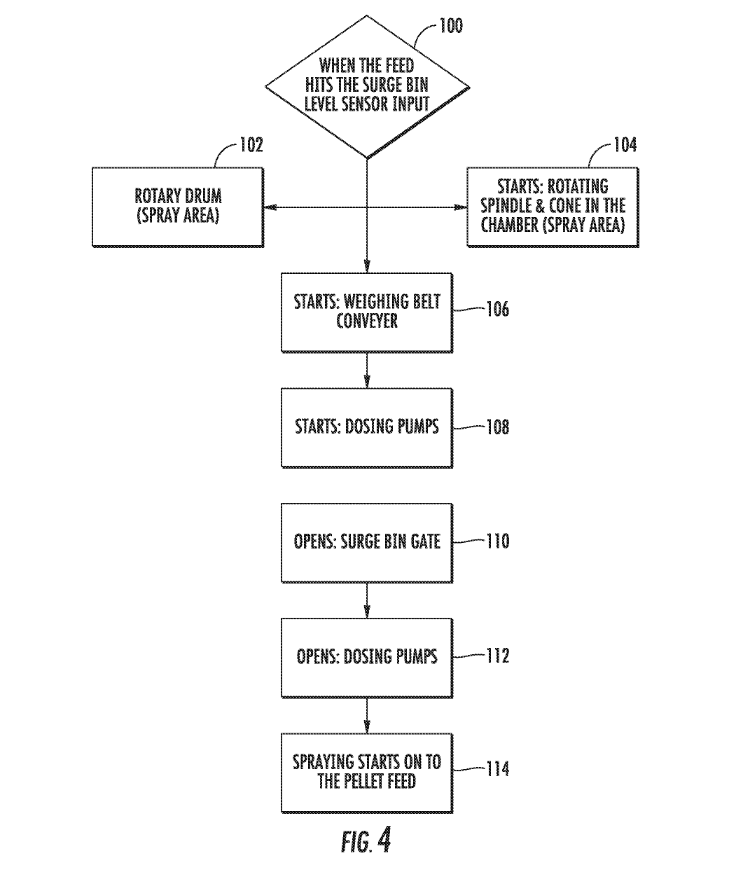

Operational Sequence. The finished dry pellet feed after cooling and sieving will be stored in the surge bin 20. Once the feed is poured into the bin 20, an input signal is sent to the surge bin level sensor. The signal from the surge bin level sensor is sent to the automation panel 34 and the panel 34 uses the input signal to start the operation sequence. The operational sequence is shown in FIG. 4. When the automation panel 34 receives the signal that the surge bin 20 has an amount of dry feed, the panel 34 sends the signal to the rotary drum 60, the cone 58, and the nozzle assembly 60 to begin spinning, to the belt feeder to begin moving, and to the dosing pumps to begin sending the liquid enzyme solution and the diluent to the static mixer 88. The surge bin gate opens, dispensing dry pellet feed onto the belt feeder 30, and the compressor 90 to send compressed air to the nozzles 62.

When the pellet feed reaches the spray area 54, the air atomizing rotating nozzles 62 create a cloud of mist in the area around the circumference of the spray duct 50 and the pellets passing through will be coated with a layer of liquid enzyme that has been mixed within and is coming from the static mixer 88. The automation panel may monitor the droplet size of the mist, the amount of feed being introduced into the spraying chamber 50, the amount of enzyme and diluent being used, or any combination of the above stated factors to speed up any of the motors, pumps and compressor to automatically to get the most efficient spray onto the pellet feed.

Droplet size analysis. The spinning nozzles 62 used in the spraying chamber 50 of the PPLA system may be subjected to drop size analysis. The drop size measurements are preferably taken with a SYMPATEC particle size analyzer, but any other particle size analyzer with the ability to analyze particles of the sizes below may be used. The equipment may use a laser diffraction method that measures the drop size based on the energy of the diffracted light caused by drops passing through the analyzer. The intent of this analysis is to examine the droplet size and spray coverage under specified conditions as set out in Table 1, below. In this particular analysis, the volume median diameter (DV 0.5) and Sauter mean diameter (D32) drop size statistics (Engelen G. M. A., and Van Der Poel A. F. B. 2007. Post-pelleting application of liquid additives. Wageningen academic publishers) were used to evaluate the drop size data. Unfiltered and unaltered water was used in the test.

TABLE 1
Droplet size analysis using different air pressure.

| | Water pressure | Air pressure | Test distance |
|---|---|---|---|
| Item | (bar) | (bar) | (mm) |
| Spray nozzle | 1 | 1 | 44 |
| | 1 | 2 | 44 |
| | 1 | 4 | 44 |
| | 1 | 6 | 44 |
| | 1 | 7 | 44 |

Enzyme used for standardization. Kemzyme® Plus Liquid (Kemin Industries, Inc., Des Moines, Iowa) at 100 g/ton dosage was used for this particular test. This enzyme is a multi-component enzyme blend that contains xylanase, cellulase, glucanase, and amylase. Kemzyme® Plus Liquid was diluted 10 times and used for standardization experiments.

Standardization of PPLA. For this particular test, the standardization of the PPLA instruments were checked for precision and accuracy of dosing. The standardization was carried out by measuring the exact volume of water discharged through each nozzle at specific setting conditions. The volume of water discharged is measured using graduated measuring cylinders (100 mL). Kemzyme® Plus Liquid was used for the standardization of the instruments.

### Results

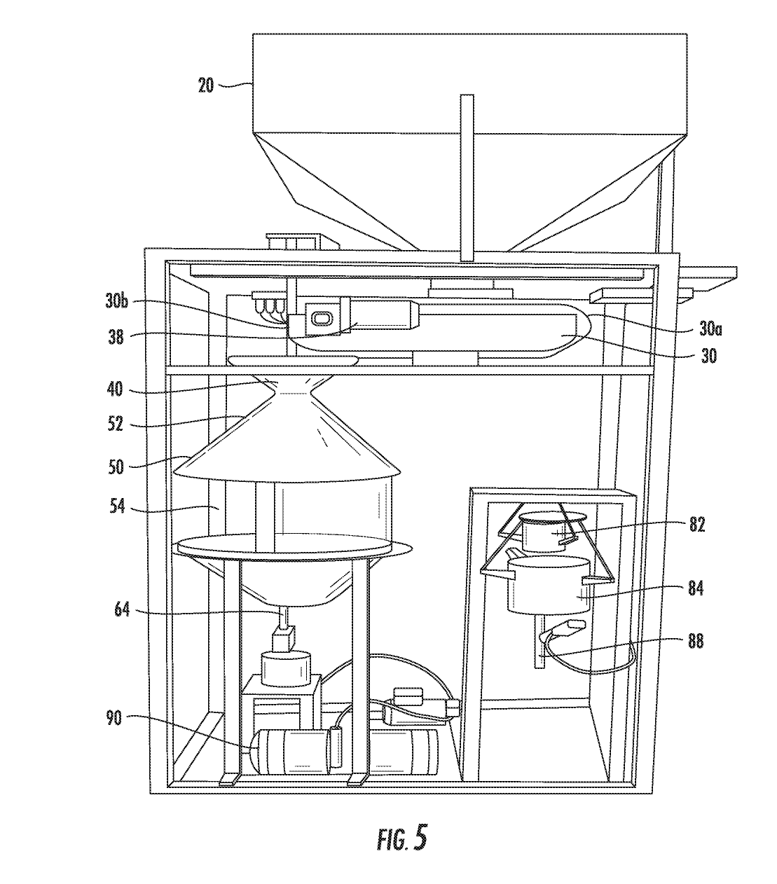

Design and fabrication. At least one embodiment of the present invention is shown in FIG. 5. As shown, the working capacity of the VSC is 50 kg/minute. The system is completely automated and is designed for one touch optimization. This system can be used in an existing feed mill with only minor modifications required to the process line.

Droplet size analysis. Tests were run to determine the effect of changes in air pressure on droplet size. The results are shown in FIG. 6 and demonstrate that an increase in the air pressure decreases the droplet size. The decreased droplet size will increase the number of droplets sprayed over the feed, thereby improving the homogeneous distribution of the liquid sprayed on the feed.

Standardization of PPLA. The results shown in Table 2 demonstrate that the VSC system has a homogenous discharge of liquids through all the four nozzles. All the nozzles provided homogeneity in spraying and repeatability.

TABLE 2
Accuracy and precision in dosing of vertical spin cone system

| | | | | | | | Total |
|---|---|---|---|---|---|---|---|
| | | | | | | | enzyme |
| Fre- | | | | | | | dis- |
| quency | Stroke | Time | Nozzle | Nozzle | Nozzle | Nozzle | charged |
| (Hz) | (%) | (min) | 1 (ml) | 2 (ml) | 3 (ml) | 4 (ml) | (ml) |
| 162 | 45 | 1 | 12 | 12 | 13 | 13 | 50 |
| 162 | 45 | 1 | 12 | 12 | 13 | 13 | 50 |
| 162 | 45 | 1 | 12 | 12 | 13 | 13 | 50 |

### Discussion

Post-pelleting liquid application (PPLA) of enzymes is an emerging practice in the feed industry, particularly in the poultry industry. The PPLA application of the present invention will increase the profitability for the poultry feed manufacturers by overcoming the problem of undesirable loss of enzymes in pellet feed, thereby increasing the nutritional value of the feed. Developing precise PPLA equipment will solve the problem for the heat sensitive feed additives. This will also advantageously alter the feed ration with cheaper alternatives along with the variable enzyme dosing.

The general criteria for the post-pelleting liquid applicator system is to have accurate ingredient metering, uniform ingredient distribution, and absorption of liquids into the pellet, with liquid (enzyme) and dry material (feed) contained in a closed system. The major difficulty in developing a PPLA system is to get all the above standards yet still provide a cost-effective solution and an application that is user-friendly and consistent.

In the prototypes developed, the system is completely automated which gives accurate incredient metering. The spraying takes place in a contained environment. Uniform ingredient distribution is attained by increasing the number of droplets each of a smaller size.

### Example 2—Efficacy Evaluation of Post Pelleting Liquid Applicator Systems

### Materials and Methods

Enzyme used in the trial. For this trial, Kemzyme® Plus Liquid was used. This enzyme is a multi-component enzyme blend that contains xylanase, cellulase, glucanase, and amylase. The Kemzyme® Plus Liquid was diluted 10 times (100 g enzyme in 900 g of water) and used for application trials.

PPLA trials. These trials were carried out using the vertical spin cone system (VSC) as disclosed in Example 1 of the present application. The systems were standardized for ingredient metering, both the liquid (enzyme and water combination) and solid (pelleted feed) flow rate before starting the application trials. The pellet feed used in the trials were procured from a commercial feed mill in India. The Pellet Durability Index (PDI) of the feed was 75% and the feed was corn—soya based finisher feed for broilers. In the PPLA trials, the enzyme was sprayed on to the pelleted feed at desired dosage. Two independent trials were performed using a Horizontal Drum (HRD) post-pelleting liquid application system at a feed flow rate of 30 kg/min and enzyme flow rate of 30 ml/min. Four trials were conducted using VSC system at a flow rate of 50 kg/min and 50 ml/min for feed and enzyme respectively. In each trial, 10 samples were collected randomly at different points for enzyme recovery analysis. The parameters investigated in the trials were PDI, xylanase recovery from feed and coefficient of variation (CV). The PDI was measured through an NHP 100 Holmen portable pellet durability tester as per the standard instructions. From the samples collected, about 25 g of pellets were taken for analysis at each sampling point. The spraying efficiency of the equipment was measured by estimating the uniformity of enzyme distribution in feed samples. The enzyme recovery was performed as per a method well known in the industry. The recovery was determined using the linear regression of Kemzyme® Plus Liquid (standard) at linear dosages (50, 100, 150, 200, 250 g/ton). A standard curve was drawn using the xylanase activity values obtained from the standards at linear dosage against the absorbance. The treated feed can be read from the standard curve using the net absorbance obtained with the test sample.

### Results

PPLA trials. The results of the enzyme distribution on pelleted feed after post pelleting application of enzymes are shown in Tables 3. The enzyme recovery was in the range of 70 to 100% and a coefficient of variation (CV) of 11 to 15% for vertical spin cone system (Table 3).

TABLE 3
Distribution of enzyme on pellet feed sprayed with Kemzyme ® Plus
Liquid through vertical spin cone.

| | Enzyme recovery % | | | |
|---|---|---|---|---|
| Samples | Trial 1 | Trial 2 | Trial 3 | Trial 4 |
| T1 | 89.99 | 87.69 | 61.22 | 99.31 |
| T2 | 66.80 | 68.59 | 70.18 | 98.15 |
| T3 | 78.42 | 71.81 | 57.22 | 89.82 |
| T4 | 71.84 | 70.36 | 80.93 | 96.13 |
| T5 | 80.88 | 77.44 | 90.18 | 110.74 |
| T6 | 76.08 | 83.46 | 78.25 | 112.73 |
| T7 | 65.44 | 63.95 | 59.42 | 104.88 |
| T8 | 70.52 | 76.56 | 73.73 | 110.19 |
| T9 | 65.79 | 62.98 | 63.20 | 75.75 |
| T10 | 63.75 | 60.62 | 66.15 | 110.44 |
| Average | 72.95 | 72.35 | 70.05 | 100.81 |
| Standard Deviation | 8.37 | 8.92 | 10.66 | 11.63 |
| Coefficient of variation (%) | 11.47 | 12.33 | 15.21 | 11.54 |

Pellet durability index. From Table 4, it is apparent that there is no significant difference observed in PDI of control feed and the feed passed through the applicator system after enzyme spraying.

TABLE 4
Pellet durability index of the feed before & after PPLA application.

Pellet durability index

| Groups | VSC | HRD |
|---|---|---|
| Control | 74.81 ± 0.26^{a} | 74.8 ± 0.52* |
| Trial 1 | 74.61 ± 0.24 ^{a} | 74.1 ± 0.06* |
| Trial 2 | 74.90 ± 0.64 ^{a} | 74.1 ± 0.89* |
| Trial 3 | 74.53 ± 0.33 ^{a} | Not available |

Each value represents the mean PDI (Mean ± SD, n = 3, P > 0.05).
The significant difference between the control and trial samples were represented as different alphabets for VSC and with different symbols for HRD.

### Discussion

The critical efficiency factors of a PPLA system is it ability to apply the liquid uniformly onto the pellets. Over dosage or under dosage of enzyme in the feed is undesirable as it impacts the performance of the animal, for instance, poultry, in addition to increasing the cost per treated ton of feed. Generally, in a post-pelleting liquid application the uniform distribution of any additives in the feed pellets is determined by the proportion of sprayed pellets to the total number of pellets. If the PPLA can achieve a higher percentage of sprayed pellets, the desired CV can be achieved.

From the results (Table 3), it is clear that PPLA systems exhibits good efficiency in terms of uniformity in spraying, with a lower CV. The PPLA systems used have an air atomizing nozzle, which is efficient in generating fine droplets of enzyme solution. The nozzles used in the PPLA systems deliver a droplet size of less than 25 microns. The smaller the droplet size, higher the number of droplets sprayed over the feed. Therefore, the ratio of sprayed pellets were improved in the total mixture.

Though all the trials were performed in the same conditions, for the VSC the fourth trial showed a higher recovery. From Table 4, it was observed that there was no significant difference in the pellet durability index of the control feed and the feed passed through the independent PPLA system, demonstrating that the PPLA system is not having a negative effect on pellet quality.

### Example 3—Nozzle Assembly

Post pelleting liquid application. In the pilot system, the nozzle design had a spinning arrangement with a 360-degree rotation, which provided a uniform coating of liquid on the final pellets. In the commercial-scale system, the post pelleting liquid applicator system was scaled up with modifications to address effective distribution. For instance, in the commercial system, the nozzle assembly was modified to suit the increased commercial requirements and to ensure uniform distribution of the enzyme liquid onto the pelletized feed.

New nozzle assembly. Specifically, the new nozzle assembly included a set-up of at least 16 nozzles, with at least 8 inner and 8 external nozzles placed below the spinning cone. Both the inner and external were placed at 45° angle in order to cover the 360° angle as shown in FIG. 7. Instead of rotating assembly with 360° rotation, the new nozzles are placed in static mode covering the 360° of spraying. The new nozzle assembly is placed in such a way that when the pelleted feed flows as falling stream from the spinning cone, the mist of liquid will be sprayed on both side as depicted in the FIG. 8.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

We claim:

1. An apparatus for spraying a liquid onto pelleted feed, comprising:
a hopper having a gate configured for selectively holding or allowing the dropping of dry pellet feed;
a spraying chamber disposed below the hopper, the spraying chamber comprising an upper portion configured to receive the dropping dry pellet feed from the hopper, and a cylindrical lower portion;
a cone rotatably attached to a motor, the cone disposed within the upper portion of the spraying chamber and configured to direct dry pellet feed received into the upper portion into a single layer of falling feed around a circumference of the lower portion;
an enzyme chamber
a nozzle rotatably disposed within the lower portion, the nozzle configured to substantially evenly spray an amount of liquid from an enzyme chamber on the single layer of falling feed.

2. The apparatus of claim 1, further comprising a mixing chamber, wherein the mixing chamber is configured to mix an enzyme solution with a diluent.

3. The apparatus of 2, further comprising a first batch tank and a second batch tank, the first and second batch tanks each located upstream the mixing chamber.

4. The apparatus of claim 3, wherein the first batch tank contains an enzyme solution.

5. The apparatus of claim 4, wherein the second batch tank contains a diluent.

6. The apparatus of claim 5, wherein the diluent is water.

7. The apparatus of claim 3, further comprising a first dosing pump associated with the first batch tank, and a second dosing pump associated with the second batch tank.

8. The apparatus of claim 7, wherein the mixing chamber is configured to mix the enzyme solution and the diluent.

9. The apparatus of claim 8, further comprising a surge bin configured to accept dry pellet feed from a user, the surge bin having a gate at a bottom portion to selectively allow feed to drop out of the surge bin.

10. The apparatus of claim 9, further comprising a belt feeder with a motor, the belt feeder having a first end disposed below the bottom portion of the surge bin and a second end disposed above an open top portion of the hopper, the belt feeder configured to deliver dry pellet feed from the surge bin into the hopper.

11. The apparatus of 10, further comprising a first load cell associated with the first batch tank, a second load cell associated with the second batch tank, a third load cell associated with the belt feeder, and a controller in electrical communication with the first, second, and third load cells, the first and second dosing pumps, the belt feeder motor and the cone motor.

12. The apparatus of claim 11, wherein the controller controls at least one of a speed of the belt feeder, a speed of the rotation of the cone, and the first and second dosing pumps, based on the electrical signals received by at least one of the first, second, and third load cells, the first and second dosing pumps, the belt feeder motor and the cone motor.

13. An apparatus for spraying an enzyme solution onto dry feed, comprising:
a surge bin for receiving and storing dry feed;
a hopper in communication with the surge bin to accept dry feed from the surge bin, the hopper having a gate configured for selectively holding or allowing the dropping of dry pellet feed;
a spraying chamber disposed below the hopper, the spraying chamber comprising an upper portion configured to receive the dropping dry pellet feed from the hopper, and a spraying portion below the upper portion;
a cone rotatably attached within the upper portion of the spraying chamber, the cone configured to direct dry feed received into the upper portion into a single layer of falling feed radially around a circumference of the lower portion;
an enzyme mixing chamber with an enzyme solution in fluid communication with the spraying portion;
a nozzle in fluid communication with the enzyme mixing chamber and rotatably disposed within the lower portion, the nozzle configured to substantially evenly spray an amount of liquid from an enzyme chamber onto individual pieces of the single layer of falling feed.

14. The apparatus of 13, further comprising a first batch tank and a second batch tank, the first and second batch tanks each fluidly coupled with the enzyme mixing chamber.

15. The apparatus of claim 14, wherein the first batch tank contains an enzyme solution, and the second batch tank contains a diluent.

16. The apparatus of claim 15, wherein the diluent is water.

17. The apparatus of claim 14, further comprising a first dosing pump associated with the first batch tank, and a second dosing pump associated with the second batch tank.

18. The apparatus of claim 17, further comprising a surge bin configured to accept dry pellet feed from a user, the surge bin having a gate at a bottom portion to selectively allow feed to drop out of the surge bin.

19. A method of evenly applying a liquid enzyme sulution to dry pellet feed comprising the steps of:
adding an amount of dry pellet feed into a surge bin;
selectively dispensing the amount of dry pellet feed out of the surge bin onto a belt feeder;
sensing the amount of dry pellet feed on the conveyer using a first load cell;
conveying the amount of dry pellet feed on the belt feed into a hopper;
sensing the amount of dry pellet feed in the hopper using a second load cell;
selectively dispensing the amount of dry pellet feed from the hopper into a spray chamber having a cone-shaped upper portion with an open end, and a cylindrical spray portion;
arranging the amount of dry pellet feed into a single layer of feed dispersed around the circumference of the spray portion by providing a rotating cone within the upper portion;
forming an enzyme mixture by mixing an amount of enzyme solution from a first batch tank and a diluent from a second batch tank in a static mixer, wherein the enzyme solution and the diluent are pumped to the static mixer by dosing pumps;
sensing the amount of enzyme solution in the first batch tank using a third load cell;
sensing the amount of diluent in the second batch tank using a fourth load cell;
spraying individual pieces of the dry pellet feed by urging the enzyme mixture through a spinning nozzle, wherein the spinning nozzle is disposed in the spray portion below the rotating cone, and is in fluid communication with the static mixer.

20. The method of claim 19, further comprising the step of:
controlling at least one of a speed of the belt feeder, a speed of the rotation of the cone, and the first and second dosing pumps, with a controller in electrical communication with the first, second, third and fourth load cells, the first and second dosing pumps, a belt feeder motor and a cone motor, based on electrical signals received by at least one of the first, second, third and fourth load cells, the first and second dosing pumps, the belt feeder motor and the cone motor.
